(19) United States
(12) Patent Application Publication
(10) Pub. No.: US 2025/0080788 A1
(43) Pub. Date: Mar. 6, 2025

(54) AUTOMATED POLICY ENGINE FOR PROCESSING DIGITAL ADVERTISEMENTS IN STREAMING MEDIA

(71) Applicant: DISH Network L.L.C., Englewood, CO (US)

(72) Inventors: Kathryn Stankiewicz, Englewood, CO (US); Mark Hurst, Cedar Hills, UT (US)

(73) Assignee: DISH Network L.L.C., Englewood, CO (US)

(21) Appl. No.: 18/819,170

(22) Filed: Aug. 29, 2024

Related U.S. Application Data
(60) Provisional application No. 63/580,282, filed on Sep. 1, 2023.

(51) Int. Cl. H04N 21/2668; H04N 21/81; H04N 21/845

(52) U.S. Cl. CPC H04N 21/2668; H04N 21/812; H04N 21/8455

(57) ABSTRACT

Metadata relating to advertisements in a television or other media stream can be automatically evaluated and filtered for more efficient ad replacement. A received media stream, for example, can be evaluated by an ad identification system or the like to identify advertisements, and to create an ad marker structure that describes the ad. The marker is ultimately provided to an ad replacement system that manages the actual replacement in streams delivered to individual viewers. In the meantime, however, the marker can be further evaluated to “pre-quality” the associated ad for replacement, to filter the ad marker so that the marker information is more accurate, or to create “pods” of consecutive replaceable ads.

### PRIORITY CLAIM

This application claims priority to U.S. Provisional Application Ser. No. 63/580,282 filed on Sep. 1, 2023, which is incorporated herein by reference.

### TECHNICAL FIELD

The following generally relates to automated processing of digital advertisements in streaming media programs. More particularly, the following relates to systems, devices and automated processes to automatically process digital advertising content in digital media streams.

### BACKGROUND

The emergence of streaming technologies has revolutionized the way people consume television and other media content. Gone are the days of waiting for a scheduled program to air on traditional television networks. With media streaming platforms like SLINGTV, YOUTUBE TV, NETFLIX and the like, viewers now have the freedom to watch their shows and movies whenever and wherever they please. This shift has led to a significant increase in cord-cutting as more and more individuals opt for streaming services over traditional cable or satellite subscriptions.

One of the biggest advantages of streaming platforms is the ability to deliver targeted advertisements to viewers. Unlike traditional television advertising that broadcasts the same advertisements to a wide range of audience members, streaming services can tailor ads based upon viewer interests and demographics, if desired. Streaming platforms can therefore deliver advertisements that are more relevant to the viewer's interests. This not only enhances the viewer's overall experience by reducing irrelevant and repetitive ads but also presents a unique opportunity for advertisers to reach their target audience more effectively.

The emerging fields of streaming media and ad targeting can present several technological challenges. In particular, efficiently processing digital advertising data can be daunting due to the large numbers of ads that are encountered on the various channels and networks often handled by media streaming services, as well as the large number of individual customers who may receive the particular ads. It is often desirable to process advertisements as quickly as possible to prevent increasing delays behind a live broadcast, particularly if the broadcast contains a sporting event or the like. Data processing systems used in streaming media advertisement distribution must therefore be capable of quickly handling customized advertisements delivered to a wide variety of viewers who are enjoying a wide variety of different programs.

It is therefore desirable to create systems, devices and methods to manage digital advertisements in media streaming systems that are efficient, yet robust and powerful enough to manage a large number of ads distributed across multiple channels and viewers.

### BRIEF SUMMARY

According to various embodiments, automated systems and processes are provided to automatically insert digital advertisements in a digital media stream. In one example, the automated process suitably comprises: recognizing a plurality of advertisements in the digital media stream; identifying each of the plurality of digital advertisements with a digital marker that identifies the digital advertisement; recognizing a group of replaceable advertisements in the media stream based upon the digital markers of the advertisements; and replacing, by the data processing system, the entire group of replaceable advertisements in the media stream with one or more replacement advertisements. Other embodiments may screen recognized ads to determine if they pre-qualify for replacement, and/or may scrub marker data to reduce or eliminate gaps in the retransmitted media stream, or for any other purpose.

Other embodiments relate to data processing systems that automatically process digital markers related to digital advertisements in broadcast or other media streams. In one example, a data processing system suitably comprises a processor, non-transitory data storage and an interface to a network, wherein the non-transitory data storage comprises computer-executable instructions that, when executed by the processor, perform an automated process as described herein.

These and other example embodiments are described in increasing detail below.

### DRAWING FIGURES

FIG. 1 shows an example of a system for automatically processing digital advertisements in a digital media stream.

FIG. 2 is a flowchart illustrating an example of an automated process for handling advertisement marker data in a digital media stream.

FIG. 3 is a flowchart illustrating an example of an automated process for managing limits on replacement advertisements at different times in a digital media stream.

FIG. 4 is a diagram of an example collection of advertisements grouped into a replaceable pod in a digital media stream.

FIG. 5 is a flowchart of an example of an automated process for handling back-to-back replaceable advertisements in a digital media stream.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

According to various embodiments, data describing advertisements in a television or other media stream can be evaluated and filtered for more efficient replacement. In one example, an ad identification system or the like identifies advertisements in a media stream, and provides an ad marker structure that identifies the ad in the media stream. The marker is ultimately provided to an ad replacement system that manages the actual replacement in streams delivered to individual viewers. In the meantime, however, it can be very useful to further evaluate the marker to “pre-qualify” the associated ad for replacement, and/or to filter the ad marker so that the information is more accurate. Metadata associated with the ad marker can therefore be used for subsequent processing by an ad replacement system of the like. Various embodiments can provide additional processing, as desired.

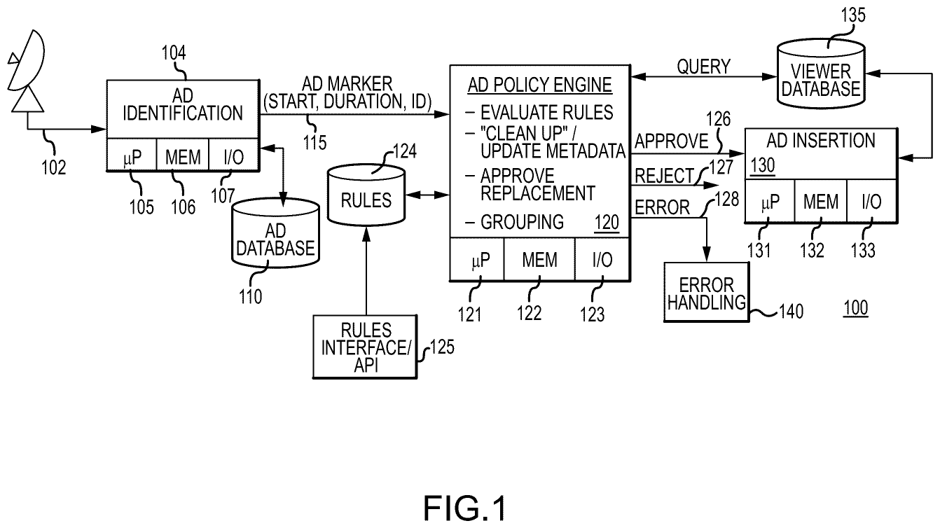

Turning now to the drawings and with initial reference to FIG. 1, an example data processing system 100 for handling ad replacements in media streams suitably includes an ad identification system 104, an automated policy engine (APE) 120, and an ad insertion/replacement system 130. The ad policy engine 120 appropriately receives ad markers 115 identifying particular ads in a television or other media stream 102 that are recognized by the ad identification system 104. Ad policy engine 120 evaluates and/or filters the ad markers based upon one or more policy rules, and may adjust the duration shown in the ad marker if desired. The duration may be adjusted, for example, based upon start times of adjoining ads or other parts of the media stream. Certain ads may be pre-approved for replacement by APE 120 based upon any number of different factors such as a time of day, a number of previously-approved ads for that time, and/or any number of other factors. Ad policy engine 120 may also identify groups or “pods” of replaceable ads. If two consecutive fifteen second ads are identified as replaceable, for example, then both of the ads could be replaced with a single 30-second ad if desired. Ads that qualify for replacement can therefore be identified to the ad replacement system 130 for subsequent processing in individual media streams provided to different media players as appropriate. Put another way, the ad policy engine 120 is able to analyze ads (or other segments) in a received media stream and to provide appropriate instructions for downstream processing to perform more intelligent insertion or replacement of ads that are provided in retransmitted streams distributed to individual playback devices.

To that end, a feed of a television channel or other input media stream 102 is initially received by an ad identification system 104 in any manner. Ad identification system 104 appropriately identifies advertisements (and/or other media segments) in the received stream 102 using any desired techniques. In one example, ad identification system 104 uses automated content recognition (ACR) software available from any source, such as the Ad Sonar software available from DISH Technologies L.L.C. of Englewood, CO, although equivalent embodiments could use other hardware, software or firmware based recognition systems, including any sort of cloud based content recognition services. In various embodiments, the ACR software recognizes audio or visual patterns in the digital media stream that can be compared to “fingerprints” of previously-recognized content that are stored in an ad database 110 or the like. Often, the fingerprints are based upon Fourier or other mathematical transforms that are applied on the audio content associated with the media stream 102, although other embodiments could operate in any other manner. One example of an ad identification system is described in US Patent Publication No. 2023/0024837, incorporated herein by reference, although other embodiments could use different systems and techniques as desired.

Ad identification system 104 appropriately formats an ad marker 115 for each recognized ad. The ad marker is any sort of data structure or the like that can be populated with appropriate data. Various embodiments implement ad markers 115 using extensible markup language (XML) or the like; equivalent embodiments could use Javascript Object Notation (JSON), comma separated values (CSV) and/or any other formats as desired, including any sort of proprietary or non-standard format.

In the embodiment illustrated in FIG. 1, ad identification engine 104 formats the ad markers 115 for recognized ads with several data fields. Example data fields could include, without limitation, such items as a name or other identifier (ID) that identifies the particular ad, a start time within the media stream 102 that the ad begins, a duration of the ad, and an indication as to whether the ad is recognized internally or externally. “External” recognition could refer to ads that are identified by the content source, e.g., the network, local affiliate or distributor. “Internal” could refer to ads that are recognized by the ad identification engine 104 based upon comparisons of fingerprint data with information in the ad database 110, as desired. Other embodiments could use different information, if desired. In some embodiments, it could be useful to include a value for whether the ad is pre-qualified for replacement when the marker 115 is created. Typically, the pre-qualified value will be initialized to be “FALSE” to prevent replacement without further analysis, although other embodiments could be configured to operate differently, if desired. Certain ads could be identified in database 110 as being pre-qualified, for example.

Ad identification engine 104 is typically implemented within conventional data processing hardware, such as any sort of processor 105, memory or other non-transitory data storage 106 and input/output interfaces 107 as desired. Some implementations may be built upon conventional computing hardware, if desired. Equivalently, the hardware shown in FIG. 1 may be partially (or completely) implemented with cloud-based services such as Amazon Web Services (AWS) or the like, if desired.

In some implementations, the ad policy engine 120 could be implemented on the same computer system so that it shares the same hardware as ad identification system 104. The example illustrated in FIG. 1 shows ad policy engine 120 operating on its own hardware, including processor 121, memory (or other non-transitory storage) 122, and input/output interfaces 123. Ad policy engine 120 could equivalently implemented using AWS or another cloud-based hardware service, if desired.

Ad policy engine 120 suitably receives ad markers 115 associated with the various ads in digital media stream 102 and appropriately “pre-qualifies” those ads that are suitable for replacement. Some implementations can additionally filter the data within the ad marker 115 to “smooth” the duration or start time, and/or for any other reason. Additionally, various embodiments are able to identify groups (or “pods”) of replaceable ads that can be flagged to the ad insertion engine 130 for more sophisticated replacement, as set forth below. Other embodiments could perform alternate or additional functions as desired.

In the example of FIG. 1, the ad markers 115 of approved ads can be forwarded to the ad insertion engine 130 for further processing. Markers 115 that are not approved can be discarded 127 and/or stored for data analysis or other purposes if desired. Various embodiments could provide an error handling system 140 to remedy ambiguous data (e.g., start times or durations that are clearly erroneous), although other embodiments could simply reject 127 the erroneous markers 115 and/or store them for further analysis if desired.

Ad policy engine 120 could implement other filters on ad markers 115 as desired. In various embodiments, an application program interface (API) may be provided through a web page or the like that allows administrative users to enter additional filter commands or other instructions using any appropriate syntax. Other embodiments could pre-approve ads for replacement based upon viewership data or other information about the ad itself, if desired. Such information may be retrieved, for example, by placing a query 129 to a viewership database 135, to ad database 110, and/or to any other data source. Queries 129 may be formatted in any manner, such as using the structured query language (SQL) or the like.

In various embodiments, multiple filter commands could be abstracted using a macro or the like. Macros allow for the automation of a sequence of commands, enabling administrators to reduce repetitive tasks and ensure consistent execution. By creating a single macro that encapsulates multiple commands, users can streamline their workflow and achieve results with as little as a single click, command word or keyboard shortcut. This not only saves time but also minimizes the chances of errors or typos that could occur when manually typing each command. Additionally, using a macro provides a level of abstraction that simplifies the complexity of the syntax commands, allowing users to focus on their specific tasks without getting lost in the details of the code. Macros could therefore prove to be a time-saving and efficient approach compared to individually typing each command, if desired. Examples where macro-type commands may be useful are provided below.

Ads in individual media streams can be replaced or otherwise processed in any manner. In the example of FIG. 1, ad insertion engine 130 receives ad markers 115 of pre-qualified ads from the ad policy engine 120 to identify ads (and/or groups of ads) that are eligible for replacement. Ad insertion engine 130 replaces the ads based upon the information contained in the ad markers 115, as well as any additional information that may be available. In many implementations, replacement could occur based upon whether the viewer has previously viewed a certain ad to improve ad reach and saturation, and to prevent repeated viewings of the same ad. One example of an ad replacement engine 130 is described in US Patent Publication No. 2023/0141399, although other embodiments could use other systems and techniques as desired.

As illustrated in FIG. 1, ad replacement engine 130 is implemented as a data processing system using conventional computing hardware, including processor 131, non-transitory data storage 132 and input/output interfaces 133. Equivalent embodiments could host ad policy engine 120 and/or ad identification engine 104 on the same hardware as ad insertion engine 130. Still other embodiments could host some or all of the functions associated with ad insertion engine 130 on a cloud-based hardware platform (e.g., AWS or the like). Other embodiments could be implemented in any other manner, as desired.

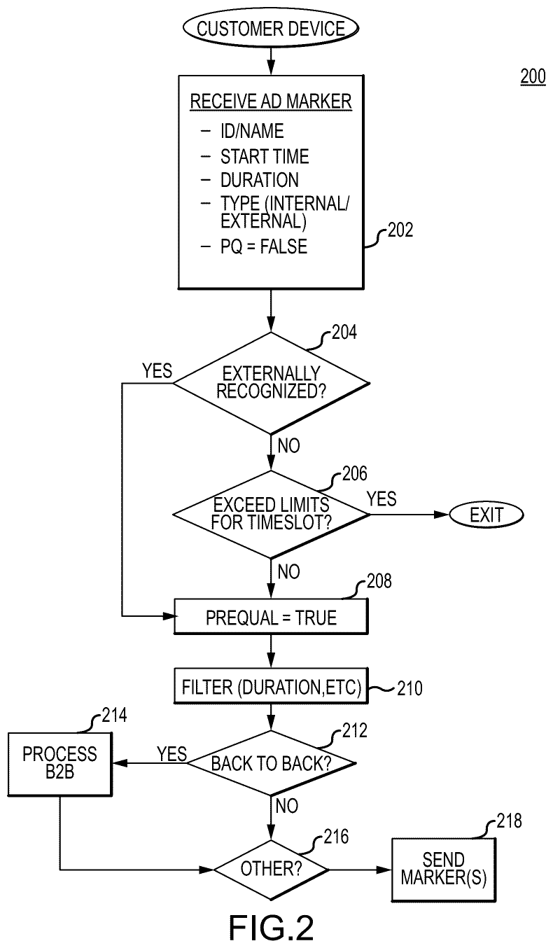

Turning now to FIG. 2, an example automated process 200 is performed by ad policy engine 120 as appropriate. Process 200 as illustrated in FIG. 2 suitably includes the broad functions of receiving ad marker 115 (function 202), pre-qualifying internally-recognized ads based upon time constraints (functions 204, 206), filtering the ad markers (function 210), and processing back-to-back replaceable ads to create “pods” that can be replaced as a group (functions 212, 214). Additional processing may be performed as desired (function 216), and pre-qualified ad markers 115 can be released to the ad insertion system 130 as desired (function 218). As noted above, the various functions shown in FIG. 2 may be implemented in hardware, software and/or firmware associated with ad policy engine 120, including any sort of cloud-based processing capability. Processor 121, for example, may perform the various functions shown by executing programmable instructions that are stored in data storage 122 or the like. Equivalent embodiments may include additional or alternate functions, and/or may be structured differently from the arrangement shown in FIG. 2.

Markers 115 of recognized ads are received in any manner (function 202). As noted above, ad markers are typically data structures formatted with several data fields to represent the data associated with a particular ad that has been identified in a media stream 102. Markers 115 may be received via network packets transmitted over a local area network (LAN) or other digital data connection to the ad identification system 104 as appropriate. Equivalently, if the ad identification system 104 and ad policy engine 120 are executing within the same computing space (including a shared cloud space) then ad markers 115 could be received via shared memory, a message queue, a named pipe, an inter-process communication (IPC) and/or any other structure as desired.

The example marker 115 illustrated in FIG. 2 includes data fields representing ad ID/name, start time, duration and type (e.g., internal or external), as well as a boolean data field indicating whether the ad is pre-qualified (“PQ”) for replacement. Ad ID/Name may refer to the content of a particular ad to permit filtering based upon the advertiser, product or ad itself. That is, certain ads may be particularly well-suited for replacement, or replacement could be blocked for ads representing a particular advertiser or product, if desired, based upon rules stored in database 124 or the like.

The pre-qualification field may be initially set to “FALSE”, if desired, by the ad identification engine 104 or by the ad policy engine 120 as appropriate. Equivalently, the logic in FIG. 2 could be configured to initialize the PQ flag to “TRUE” until the ad is recognized as ineligible for replacement, if desired, although most embodiments will likely prefer to default to non-replacement to prevent accidental replacement of ads. Other embodiments could use different data fields, if desired, to describe the various ads that are recognized within system 100.

In the example of FIG. 2, ads are processed differently depending upon whether they are recognized internally or externally (function 204). “Internally” recognized in this context refers to recognition by ad identification engine 104, as opposed to ads that are “externally” recognized based upon data provided by the advertiser, network, local affiliate, program distributor or another source. Externally recognized ads may be associated with additional data relating to ad limiting systems that aim to reduce to repetitiveness of certain ads, and/or ads may be flagged for replacement according to various policy rules, as desired.

Some implementations allow some or all of the ads to be screened to permit over-replacement during certain time periods (function 206). It may be desirable, for example, to limit replacement to only a few ads during a program, or during a particular time slot. The particular limits could vary based upon the time of day, the day of the week, the particular channel and/or any other factors as desired. In one example, programs airing during prime time (e.g., 6 μm to 10 μm central or mountain time) may allow, for example, two minutes of ad replacement during a half hour period. Programs airing during the late-night time period (e.g., 10 μm to midnight central or mountain time) could allow, for example, three minutes of replacement due to the increased local content and the different viewership for programs aired during that time period. To that end, function 206 will typically track the amount of replaceable ad time that has been pre-approved during the program or timeslot to prohibit further replacement of ads occurring after the replaceable ad quota is met. Other embodiments could attempt to stagger the pre-qualified ads throughout the time period, if desired, to prevent excessive replacement in the early minutes of the time, or for any other purpose.

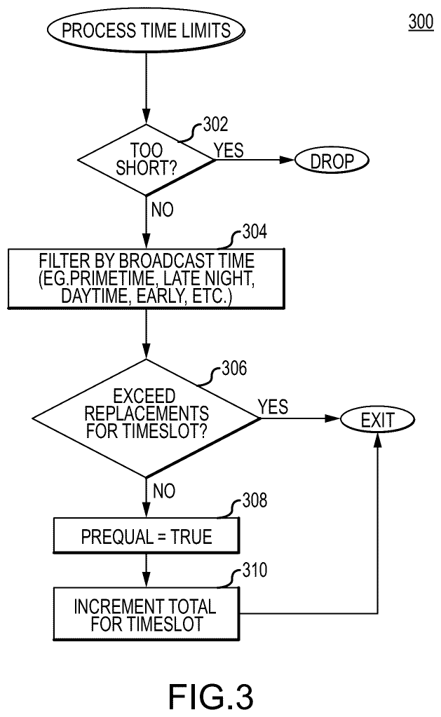

FIG. 2 illustrates an example where externally-recognized ads are automatically pre-qualified for replacement (function 208), subject to subsequent filtering. Generally this will be acceptable, since externally recognized ads are generally provided with reliable information about duration, content and the like. Moreover, externally-recognized ads may be pre-qualified for replacement by the advertiser, network, local affiliate, distributor or another entity. FIG. 2 therefore illustrates an example that only performs time limit screening on internally-recognized ads so that only internally-recognized ads count toward the predefined limits on ad replacement. Equivalent embodiments could omit the distinction between internal and external recognition (e.g., function 204) if desired. To that end, all ads could be evaluated by function 206 to ensure limits on all of the replaceable ads within a particular program or timeslot, or all ads could be evaluated without function 206's regard to such limits so that time limits are not enforced on any ads, if desired. Additional details about function 206 are provided in FIG. 3 below.

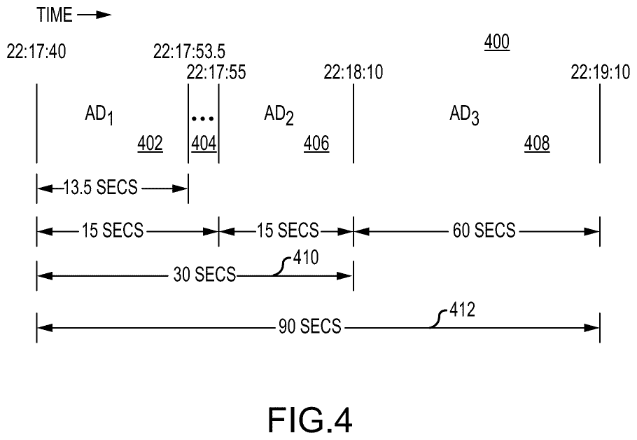

Pre-qualified ad markers may be filtered in any manner (function 210). In various embodiments, the duration and/or start time data can be automatically adjusted to “clean up” any noise or jitter induced by ad identification engine 104, or for any other purpose. If the ad duration field is recognized within an acceptable difference of an expected value, for example, the expected value can replace the actual value stored in the ad marker 115. If an ad's marker data shows a duration of 15.03 seconds or 14.93 seconds, for example, the ad can be recognized as a fifteen second ad and the duration field of the marker 115 can be adjusted accordingly. Similarly, if the ad start time is different from an expected start time (e.g., different from time that would begin immediately after a previous ad), the start time data can be suitably smoothed to reflect the actual value, thereby permitting more effective replacement in a re-transmitted media stream. Additional details about time smoothing are provided below in conjunction with FIG. 4.

Additional filtering can be applied based upon any number of other factors. Filtering could be performed in response to commands entered via an API or the like by an administrator to filter replaceable ads based upon the underlying content of the ad (e.g., permit or block replacement of ads from a certain advertiser or product), based upon the original network, local affiliate and/or distributor of the media stream 102, and/or based upon any other factors as desired. As noted above, filters could be created using a web-based or other API using any appropriate syntax. Filters could be further applied using any sort of macro structures that allow single commands to create filters that would be applied across programs, channels, networks, advertisers/products, dates and times or the like.

In the example of FIG. 2, process 200 suitably includes identifying whether replaceable ads occur during a group (or “pod”) of consecutive replaceable ads (function 212). To that end, ad policy engine 120 suitably tracks whether a previous ad was pre-qualified for replacement, and whether the start time of the current ad occurs just after the end of the previous ad. An expected end time could be readily determined from the start time and duration of the previous ad, although some embodiments could record an actual observed end time in the ad marker 115 received from ad identification engine 104, if desired. If the current ad marker is a consecutive replaceable ad (function 212), then a group of replaceable ads can be indicated to the ad insertion engine 130 to permit replacement of multiple consecutive smaller ads with a single larger ad. A group of three consecutive thirty second ads, for example, could be replaced with a single ninety second ad, a sixty second ad followed by a thirty second ad, a thirty second ad followed by a sixty second ad, two forty-five second ads, three new thirty second ads, or any other combination of replacement ads to fill the recognized timeslot. Recognizing groups of replaceable ads therefore provides additional opportunities for revenue generation and for improving the customer experience through wider offerings of engaging replacement ads.

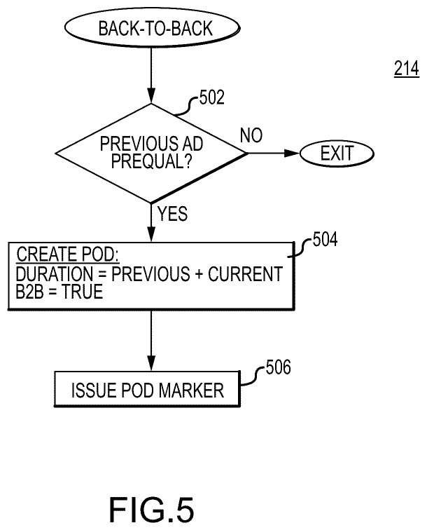

Pods of replaceable ads may be indicated to the ad insertion engine 130 in any manner. New ad markers 115 representing the pod could be created, for example. Alternatively, an additional data field could be inserted into the data markers 115 of relevant ads to identify the known start time of the pod, and the minimum allowable duration (recognizing that the durations of ad pods could increase with later recognition of additional ads, as described more fully below). Other embodiments could identify pods using separate messaging, or in any other manner. Additional detail about pod creation and processing is described in conjunction with FIGS. 4 and 5 below, and other embodiments could operate in any other manner.

Various embodiments provide additional processing as desired (function 216). Examples of other processing could include additional filtering, sorting of replacement ads, additional data tracking of potentially replaceable ads, prioritizing replacement ads and/or the like. Various embodiments may permit administrators to create additional processing routines using the API (including any sort of macro syntax), or the like.

Processed ad markers 115 can be provided as an output to ad insertion engine 130 in any manner (function 218). Ad markers 115 may be formatted into data packets delivered via a LAN or other network connection, if desired. Equivalently, if the ad insertion engine 130 and ad policy engine 120 are executing within the same computing space (including a shared cloud space) then ad markers 115 could be delivered via shared memory, a message queue, a named pipe, an inter-process communication (IPC) and/or any other structure as desired. Although this discussion maintains the term “ad marker” to described ad data received and delivered by the ad policy engine 120, equivalent embodiments could be created in which the output data structure is re-structured, re-created and/or reformatted from the input data in any manner.

With reference now to FIG. 3, an example process 300 is performed by the ad policy engine 120 to manage ad replacement time limits. Process 300 may be used to implement function 206 described with reference to FIG. 2. As noted above, process 300 may be performed only on internally recognized ads or time limits could be enforced on all ads, if desired. The various functions shown in FIG. 3 may be supplemented or differently organized in any manner.

As illustrated in FIG. 3, process 300 begins by recognizing ads that are too short to effectively process (function 302). “Too short” in this context generally relates to ads that have durations shorter than typical ads so that recognition and replacement of the ad cannot typically occur during the time span of the ad itself. If detection takes approximately five seconds or so, for example, then ads shorter than about fifteen seconds will typically be too short to effectively process. The cutoff threshold for “too short” ads will therefore vary from embodiment to embodiment, but many implementations will not bother attempting to process ads shorter than about fifteen seconds or so. Ads shorter than the threshold duration will typically be dropped from further processing and will not be pre-qualified for replacement.

Ads that are not too short, however, can be passed for further processing. To enforce the replacement limit, many embodiments will keep a running total of allowed ads that can be compared to the relevant maximum time limit for that program or time period (function 304). In the example of FIG. 3, different broadcast time slots can be associated with different amounts of ad replacement. More replacement may take place, for example, during early morning or late night broadcasts (as compared to prime time broadcasts) due to the amount of local advertising, the different viewership, and the different cost of running ads in the different time slots. In one example, two minutes of ad replacement could occur during a half hour of prime time (e.g., 7 pm to 10 pm), with three minutes per half hour allowed during late night (e.g., 10 pm to midnight) or early morning hours (e.g., 5 am to 8 am), and four minutes allowed during remaining hours. Any number of different limits could be applied in other embodiments. Some embodiments may additionally enforce time limits that are specific to certain networks or channels, or certain programs or program types, if desired. Sports programming, for example, may permit more or less ad replacement that news or drama programs, if desired.

To that end, ad policy engine 120 compares the cumulative durations of ads that are approved for replacement to the allowed replacement time for the timeslot (function 306). If the duration of the current ad would cause the total replacement time to exceed the maximum allowed time, then the “pre-qualified” flag in the ad's marker 115 will remain set to “FALSE”. If sufficient time remains to permit replacement of the current ad, however, then the pre-qualified flag can be set to “TRUE” (function 308), and the total time of replacement ads for that timeslot can be incremented as appropriate (function 310). In various embodiments, the duration of the ad as indicated in the ad's marker 115 is added to the cumulative durations of previously-qualified ads, thereby maintaining a running total of ads that have been qualified for replacement. The total can be reset at the end of the program or time period, as desired.

FIG. 4 illustrates one example of a “pod” 400 of pre-qualified advertisements in media stream 102 that can be replaced with a single replacement ad, if desired. In the example illustrated in FIG. 4, a ninety second stretch of time beginning at 22:17:40 includes a first ad 402 having a measured duration of 13.5 seconds; a brief gap 404 extending for about 1.5 seconds; a second ad 406 having a duration of about fifteen seconds; and a third ad 408 extending for sixty seconds. This example was generated to illustrate the concepts of ad grouping and gap replacement; practical embodiments will almost certainly have different combinations of ads, gap time, program content and the like.

In the example of FIG. 4, each of the ads 402, 406 and 408 are assumed to be replaceable ads so that the entire pod 412 could be replaced with a single ninety second ad, if desired. To recognize this, ad policy engine 120 first needs to identify each ad 402, 406 and 408, as well as gap 404, as representing replaceable time. Generally, the system will first receive and process the marker 115 for ad 402, which would indicate a 13.5 second replaceable ad slot. Approximately fifteen seconds later, the system will receive the marker 115 for ad 406, which will indicate the start time and duration of ad 406. By comparing the start time of ad 406 with an expected start time based upon the start time and duration of ad 402, the gap 404 can be identified. In this instance, the gap is only about 1.5 seconds long, meaning that it is unlikely to contain program content or other meaningful content. Often, such gaps can occur due to slow response times by local affiliates or distributors, or due to other issues. Given that the expected start time of ad 402 differs by a small amount of time from the actual start time, and given that the 13.5 second duration of ad 402 is an unusual duration, it can be automatically deduced that the correct duration of ad 402 should be fifteen seconds and gap 404 can be ignored. In other examples, the gap 404 may not correspond to an expected inaccuracy in an ad duration; that is, an actual gap could occur between full length ads. Gap 404 may nevertheless be ignored for grouping and ad replacement purposes, since it does not represent program content that would be missed if the program stream 102 were altered.

Pod duration could increase as the media stream is received due to the inability to “look ahead” in most broadcasts, and due to some delay being inherent in the ad detection process. In some embodiments, ad detection takes about five seconds or so. Continuing the example of FIG. 4 and assuming a five second detection delay, a thirty second pod 410 of replaceable time would be recognized around time 22:18:00 (i.e., about five seconds after the start of ad 406). Some implementations may therefore allow immediate replacement of ads 402 and 406 (as well as gap 404) with a thirty second ad, without waiting for the pod to be complete. If the pod is allowed to progress for an extra fifteen seconds or so, the system will identify the third ad 408 around 22:18:15, thereby permitting a ninety second replacement pod 412 spanning the time of 22:17:40 to 22:19:10. If additional replacement ads were to follow this example, the next ad would be recognized around 22:19:15 or so, thereby permitting an even larger pod. Various embodiments could manage the evolving pod discovery in any number of different ways, as described more fully below.

Pod replacement can provide several advantages to the content provider and to the viewer. Longer replacement ads can produce more revenue for the content provider, but they also can be more engaging for the viewer and can provide more complete information about a product or service that is of greater interest to the viewer. Pod replacement therefore provides substantial benefits over conventional ad replacement in many instances.

FIG. 5 is a flowchart of an example automated process 214 performed by ad policy engine 120 to group back-to-back replaceable ads into pods. As shown in FIG. 5, the system processes a pre-qualified ad marker 115 by first determining whether immediately preceding pre-qualified ads have been encountered (function 502). If the prior content was a pre-qualified ad, then the newly-received ad can be assumed to be part of a pod, and processing will continue with function 504. If not, then the ad's information (e.g., start time and duration) will be saved for further processing if subsequent pre-qualified ads are identified.

Function 502 may also consider whether small gaps have been found in the media stream (e.g., gap 404 discussed above). To that end, it may be beneficial to compare an expected start time of the ad (e.g., the start time plus duration of the prior ad) to an actual start time of the current ad. If the expected start and the actual start differ by only a small amount of time (e.g., one or two seconds or so), then the difference may be assumed to be a content-free gap that can be removed or replaced in subsequent processing. The duration of the previous ad stored in the ad's marker 115 may be corrected in some implementations, or the difference could be simply reflected in a separate marker 115 issued for the pod, or otherwise as desired.

Pods of replaceable ads can be created in any manner (function 504). In various embodiments, the pod is recognized when the current pre-qualified ad marker is consistent with an immediately-preceding pre-qualified ad and/or a replaceable gap. The pod can be characterized by its start time (e.g., corresponding to the start time of the first ad in the pod) and duration (e.g., corresponding to the summed durations of the ads in the pod, plus any replaceable gap time). This information may be stored for further use in any manner.

In some implementations, a “POD” field could be added to the markers 115 of relevant ads. The POD field could be marked “true” if the ad is part of a POD, and a downstream replacement system (e.g., ad insertion engine 130) would process the information available as appropriate. If the stream is being retransmitted live, then pod processing may be more limited than if the stream is being transmitted with substantial delay behind the live broadcast (e.g., from a digital video recorder). In this instance, the downstream replacement system could use any information that is available at the time of ad replacement, recognizing that larger pods may not have been identified when replacement begins. By simply flagging the markers 115 of ads that are part of pods, the system is relying upon downstream processing to recognize replaceable groups of ads, while providing flexibility to limit ad replacement on live streams, if desired.

Other embodiments could issue a separate marker 115 for pods of ads (function 506). Such markers could be similar to the markers 115 for individual ads, with data fields representing a start time and duration. Multiple pod markers 115 could be issued as additional ads are recognized and processed, if desired, or the system could issue a single pod marker 115 after the entire pod has been analyzed. Separate markers 115 could be issued for pods 410 and 412 (FIG. 4), for example, even though the two pods overlap in time. Again, faster recognition will allow for more immediate replacement in live broadcasts or the like, whereas later processing will allow for more complete replacement, including replacement with fewer ads of greater duration. Issuing multiple markers 115 for the different replaceable pods could provide advantages of fast and complete recognition, if desired, provided that downstream ad replacement processing is able recognize the overlap and react accordingly.

Various embodiments therefore relate to systems, devices and automated processes to improve ad replacement in digital media streaming. By performing filtering and other pre-replacement analysis on the ad markers, ad replacement can be made more effective, more powerful and more efficient.

The general concepts set forth herein may be adapted to any number of alternate but equivalent embodiments. The term “exemplary” is used herein to represent one example, instance or illustration that may have any number of alternates. Any implementation described herein as “exemplary” is not necessarily to be construed as preferred or advantageous over other implementations, nor is it necessarily intended as a model that must be duplicated in other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. An automated process performed by a data processing system to insert digital advertisements in a digital media stream, the automated process comprising:
recognizing a plurality of advertisements in the digital media stream;
identifying each of the plurality of digital advertisements with a digital marker that identifies the digital advertisement;
recognizing a group of replaceable advertisements in the media stream based upon the digital markers of the advertisements; and
replacing, by the data processing system, the entire group of replaceable advertisements in the media stream with one or more replacement advertisements.

2. The automated process of claim 1, wherein each of the digital markers comprises an identifier of the advertisement, a start time of the advertisement within the digital media stream, and a duration of the advertisement.

3. The automated process of claim 2 wherein the recognizing comprises determining a duration of the group of replacement advertisements by adding the durations of the advertisements making up the group.

4. The automated process of claim 2 wherein the replacing comprises replacing at least two of the advertisements in one or more of the groups with a single replacement advertisement.

5. The automated process of claim 2 further comprising filtering the digital markers associated with at least some of the digital advertisements to correct the duration of the advertisement.

6. The automated process of claim 5 wherein the filtering further comprises adapting the digital markers based upon one or more policy rules.

7. The automated process of claim 6 wherein the policy rules are input to the data processing system with a macro structure that generates multiple policy rules from a single administrator input.

8. The automated process of claim 5 further comprising placing a query from the data processing system to a database to obtain additional information about the digital advertisement, and wherein the filtering comprises adapting the digital marker based upon the additional information.

9. A data processing system comprising a processor, non-transitory data storage and an interface to a network, wherein the non-transitory data storage comprises computer-executable instructions that, when executed by the processor, perform an automated process comprising:
recognizing a plurality of advertisements in the digital media stream;
identifying each of the plurality of digital advertisements with a digital marker that identifies the digital advertisement;
recognizing a group of replaceable advertisements in the media stream based upon the digital markers of the advertisements; and
replacing, by the data processing system, the entire group of replaceable advertisements in the media stream with one or more replacement advertisements.

10. The data processing system of claim 9, wherein each of the digital markers comprises an identifier of the advertisement, a start time of the advertisement within the digital media stream, and a duration of the advertisement.

11. The data processing system of claim 10 wherein the recognizing comprises determining a duration of the group of replacement advertisements by adding the durations of the advertisements making up the group.

12. The data processing system of claim 10 wherein the replacing comprises replacing at least two of the advertisements in one or more of the groups with a single replacement advertisement.

13. The data processing system of claim 10 further comprising filtering the digital markers associated with at least some of the digital advertisements to correct the duration of the advertisement.

14. The data processing system of claim 13 wherein the filtering further comprises adapting the digital markers based upon one or more policy rules.

15. The data processing system of claim 14 wherein the policy rules are input to the data processing system with a macro structure that generates multiple policy rules from a single administrator input.

16. The data processing system of claim 13 further comprising placing a query from the data processing system to a database to obtain additional information about the digital advertisement, and wherein the filtering comprises adapting the digital marker based upon the additional information.
